(19) United States
(12) Patent Application Publication
(10) Pub. No.: US 2018/0119949 A1
(43) Pub. Date: May 3, 2018

(54) OIL AND GAS INDUSTRY WASTE STREAM REMEDIATION SYSTEM, METHOD, AND APPARATUS

(71) Applicant: Plasma Tech Holdings, LLC, Bedford, NH (US)

(72) Inventors: James Charles JURANTICH, Fort Lauderdale, FL (US); Raymond Clifford David SKINNER, Coral Springs, FL (US); Alan Craig REYNOLDS, Novi, MI (US)

(21) Appl. No.: 15/565,602

(22) PCT Filed: Apr. 11, 2016
(86) PCT No.: PCT/US16/26934

§ 371 Date: Oct. 10, 2017

Related U.S. Application Data
(60) Provisional application No. 62/146,145, filed on Apr. 10, 2015.
(60) Provisional application No. 62/264,147, filed on Dec. 7, 2015.

(51) Int. Cl. F23G 5/08; B09B 3/00; C02F 11/18; C02F 11/10; C10J 3/18; F23G 5/027; F23G 5/16; F23G 5/46; B09C 1/06

(52) U.S. Cl. CPC F23G 5/085; B09B 3/0083; C02F 11/18; C02F 11/10; C03B 37/055; F23G 5/0276; F23G 5/16; F23G 5/46; B09C 1/067; C10J 3/18

(57) ABSTRACT

A system comprising a plasma assisted vitrifier (8) configured to produce vitrified product. A feed pipe (4) can be fluidly connected to the plasma assisted vitrifier (8). The feed pipe (4) can be configured to deliver a feedstock into the plasma assisted vitrifier. A heated combustion air conduit (34) can be fluidly connected to the plasma assisted vitrifier (8). A spinning fiberizer can be disposed next to the plasma assisted vitrifier (8) and configured to receive the vitrified product (24). An emissions attenuation device can be fluidly connected to the plasma-assisted vitrifier (8) and configured to treat gaseous emissions generated by the plasma-assisted vitrifier (8).

### CROSS-REFERENCE TO RELATED APPLICATION

This application claims priority to U.S. provisional patent application No. 62/146,145 entitled “OIL AND GAS INDUSTRY WASTE STREAM REMEDIATION SYSTEM, METHOD, AND APPARATUS,” filed 10 Apr. 2015, and to U.S. provisional patent application No. 62/264,147 entitled “OIL AND GAS INDUSTRY WASTE STREAM REMEDIATION SYSTEM, METHOD, AND APPARATUS,” filed 7 Dec. 2015, which are hereby incorporated by reference as though fully set forth herein.

### BACKGROUND OF THE INVENTION

### Field of the Invention

Embodiments of the present disclosure generally relate to a method, system, and apparatus for remediating waste streams from the oil and gas drilling, recovery and upgrading processes. The waste streams can be drill cuttings, contaminated water, water treatment waste (e.g., Mature Fine Tailings (MFT)), cold heavy oil production with sand (CHOPS) by-products and/or other artifacts of the oil and gas industry. The method, system, and apparatus can in an embodiment be successfully used for the manufacturing of reclaimed syngas, heat, steam and/or power, road aggregate, fiber, frac sands and bead blasting products, abrasives, wall boards, sorbents, shingle aggregate, and/or other products.

### Description of the Related Art

The oil and gas industry currently produces large amounts of waste due to drilling activities and raw product upgrading procedures. In the drilling process, spent drilling “mud” and drill cuttings are currently deposited in landfills. Tailings from the upgrading and/or bitumen extraction process associated with open pit mines can be deposited primarily in waste ponds to eventually settle into MFT. Other methods to help mature the tailings have been attempted, however a large amount of residual MFT waste is typically the result of these methods.

The steam required for heavy oil recovery generates significant spent lime sludge and other boiler water by-products before the water and steam can be used productively. This waste product also is land filled at this time.

Upgrading occurs when crude energy product, such as bitumen from the Alberta Oil Sands, is extracted from the ground through a process such as Steam Assisted Gravity Drain (SAGD) or open pit mining, but the bitumen is still in a state that is too thick or too full of contaminants to enter a pipe line for transport to a refinery or be used in an interim higher value form. The waste products generated from this upgrading or bitumen separating process now also end up being deposited in a landfill, abandoned mine, or pond.

The oil and gas recovery industry is engaged in trying to find better solutions to their waste issues than throwing all the spent materials into a landfill or pond. All experienced, technically-competent individuals know that every landfill or pond will eventually leak. No conscientious company wants that type of long term liability risk. Many types of waste take millions of years to become neutralized before they no longer pose a threat to ground water or other living things. Life expectancies of plastic liners used in landfills or sand walls used in ponds are typically expressed in decades, not thousands or millions of years. A better, more conscientious, waste remediation system and method is needed. The oil and gas industry has spent fortunes trying to invent better waste remediation systems and methods. The challenge that typically stands in the way of success is that remediation technology is too expensive or remediation technology is not able to process the large volumes of waste feedstock required in an effective way. These two issues are obviously interrelated.

Prior art teaches methods of dealing with spent drill cuttings, such as those taught in US publication no. 2014/0151343 A1 titled, “System, Method and Apparatus For Recovering Mining Fluids From Mining By-products.” The plasma process, described therein, is a very complicated, high temperature plasma process that uses tangential flows in a chamber to attempt to secure adequate heat transfer. The production capability of this form of heat transfer system, method, and apparatus is limited. No matter how the plasma is formed (either by direct acting, projected, RF or microwave), the energy density and lack of dispersion make it difficult to consistently and cost effectively process a large mass flow using this approach.

The method and system described in U.S. Pat. No. 4,989,522 titled, “Method and System for Incineration and Detoxification of Semiliquid Waste,” generate a plasma that is fired directly into the feedstock in a chamber. Many other examples of this process have shown that the plasma heat transfer is limited again by the concentrated high energy density of a plasma torch and the poor heat transfer capability of the inorganic slag in the transfer pool. This approach also requires separation of liquid and solid waste portions as well as the feeding of the solid waste portions and the liquid portions separately. This adds to the complexity and cost of the process. The document continues to teach combusting the waste in the chamber which usually causes high mono-nitrogen oxide (NOx) concentrations due to the high inherent temperatures of plasma. The required NOx post treatment also adds to the complexity and cost of this approach. Moreover, this approach also requires reducing the concentration of water-soluble metal contaminants in a solid residue that is produced to nontoxic levels, which again adds cost.

The teachings described in U.S. Pat. No. 8,796,581 B2 titled, “Plasma Whirl Reactor Apparatus and Methods of Use,” attempt to combine RF plasma and indirect torches, in various ways, to afford heat transfer to the feedstock in the process. Due to the intense energy density of plasma, the described methods and apparatus suffer from the same issue of poor plasma heat and energy transfer. Further, the described apparatus would be both expensive and complex to construct. This combination of challenges limits the ability of the patented information to be used in a cost-effective, mass-production environment.

In U.S. Pat. No. 4,344,839 titled, “Process for Separating Oil from a Naturally Occurring Mixture,” the process again attempts to flow tar sands or other energy by-products through a plasma stream to vaporize hydrocarbons and, thus, separate them from the solid particles, allowing the solid particles to drop from the plasma and vaporized oil to be condensed. This process also attempts to work as a gas polisher with a kinetic particle separator that has not been mass produced due to the difficulty in heat and energy transfer associated with plasma relative to any feedstock. The vaporized oil will also typically convert to a syngas when gasified and not condense after being exposed to a plasma stream, as desired, due to the temperatures encountered in the plasma stream.

### SUMMARY OF THE INVENTION

Various embodiments herein provide a system comprising a plasma-assisted vitrifier configured to produce vitrified product. A feed pipe can be fluidly connected to the plasma-assisted vitrifier. The feed pipe can be configured to deliver a feedstock into the plasma-assisted vitrifier. A heated combustion air conduit can be fluidly connected to the plasma-assisted vitrifier. A spinning fiberizer can be disposed next to the plasma-assisted vitrifier and configured to receive the vitrified product. An emissions attenuation device can be fluidly connected to the plasma-assisted vitrifier and configured to treat gaseous emissions generated by the plasma-assisted vitrifier.

Various embodiments herein can provide a system, comprising a plasma-assisted vitrifier configured to produce syngas, process heat, and vitrified product. A feed pipe can be fluidly connected to the plasma-assisted vitrifier, the feed pipe being configured to deliver a feedstock into the plasma-assisted vitrifier. A heated combustion air conduit can be fluidly connected to the plasma-assisted vitrifier. A generator selected from the group consisting of a steam generation system and an electrical generation system, wherein the generator is configured to operate with at least one of the syngas and the process heat. A device selected from the group consisting of an aggregate production device configured to produce an aggregate from the vitrified product and a fiber production device configured to produce a fiber from the vitrified product, wherein the device is disposed next to the plasma-assisted vitrifier. An emissions attenuator fluidly connected to the plasma-assisted vitrifier and configured to treat gaseous emissions generated by the plasma-assisted vitrifier.

Various embodiments herein can provide a system, comprising a plasma-assisted vitrifier configured to produce syngas and process heat. A feed pipe can be fluidly connected to the plasma-assisted vitrifier, the feed pipe can be configured to deliver a feedstock into the plasma-assisted vitrifier. A heated combustion air conduit can be fluidly connected to the plasma-assisted vitrifier. A generator can be selected from the group consisting of a steam generation system and an electrical generation system, wherein the generator is configured to operate with at least one of the syngas and the process heat. A device selected from the group consisting of an aggregate production device can be configured to produce an aggregate from the vitrified product and a fiber production device can be configured to produce a fiber from the vitrified product. An emissions attenuator can be fluidly connected to the plasma-assisted vitrifier and configured to treat gaseous emissions generated by the plasma-assisted vitrifier.

Various embodiments herein can provide a system, comprising a plasma-assisted vitrifier configured to produce syngas and process heat. A feed pipe can be fluidly connected to the plasma-assisted vitrifier, the feed pipe can be configured to deliver a feedstock into the plasma-assisted vitrifier. A heated combustion air conduit can be fluidly connected to the plasma-assisted vitrifier. Various embodiments can include a generator selected from the group consisting of a steam generation system and an electrical generation system, wherein the generator is configured to operate with at least one of the syngas and the process heat. Embodiments can include a device selected from the group consisting of an aggregate production device configured to produce an aggregate from the vitrified product and a fiber production device configured to produce a fiber from the vitrified product. A siphon valve can be configured to control a flow of vitrified product from the plasma-assisted vitrifier to the device selected from the group consisting of the aggregate production device and the fiber production device. An emissions attenuator can be fluidly connected to the plasma-assisted vitrifier and configured to treat gaseous emissions generated by the plasma-assisted vitrifier.

### BRIEF DESCRIPTION OF THE DRAWING

FIG. 1 depicts a process flow diagram that includes a plasma-assisted vitrifier and associated process equipment, in accordance with embodiments of the present disclosure.

FIG. 2 depicts a more detailed side view of the plasma-assisted vitrifier and feed unit in FIG. 1, in accordance with embodiments of the present disclosure.

FIG. 3 depicts a more detailed side view of a lower portion of the plasma-assisted vitrifier in FIGS. 1 and 2, in accordance with embodiments of the present disclosure.

### DETAILED DESCRIPTION

Embodiments of the present disclosure relate to a method, system, and apparatus for remediating waste streams from the oil and gas drilling, recovery, bitumen separation process, such as the Clark Hot Water Extraction Process (CHWE), and/or upgrading processes. The waste streams can be drill cuttings, contaminated water, water treatment waste, CHOPS by-products, and/or other artifacts of the oil and gas industry. In some embodiments, the water treatment waste can result from steam generation or bitumen separation from processes such as CHWE and include Mature Fine Tailings (MFT). The method, system, and apparatus can, in an embodiment, be successfully used for the manufacturing of reclaimed syngas, heat, steam and/or power, road aggregate, fiber, frac sands and bead blasting products, abrasives, wall boards, sorbents, shingle aggregate, diluent, and/or other products.

Some embodiments of the present disclosure can be used for successfully processing large quantities of the oil and gas industry's waste and by-products both safely and in an economically viable way. Additionally, in contrast to the above noted approaches, the employed plasma heat transfer method solves the known problem of distributing the intense energy density found in plasma over a large mass and volume of feedstock. Embodiments of the present disclosure allow for large scale, efficient mass processing of waste and by-products. Further, valuable reclaimed by-products can be produced, which can contribute to the economic viability of embodiments described in the present disclosure. Embodiments of the present disclosure can successfully process the highly exothermic feedstock (bitumen) found in heavy oil drill cuttings while using minimal to no external resources; and, at the same time, produce minimal emissions. The minimal use of external resources and production of minimal emissions, associated with embodiments described herein, provides for a system, method, and apparatus that are economically viable.

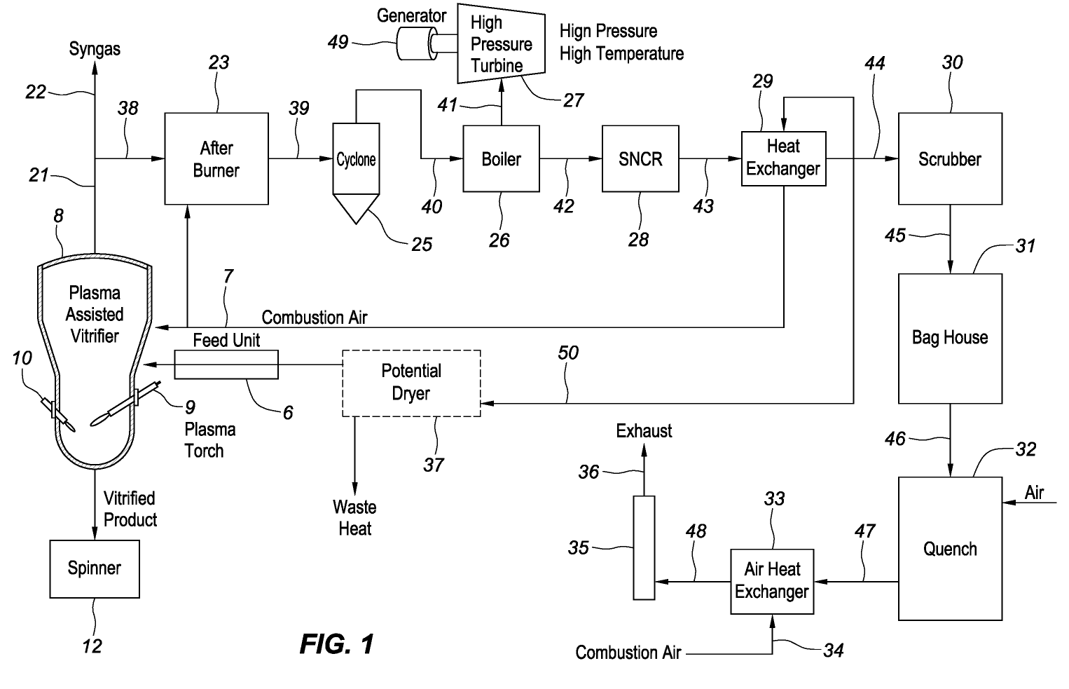

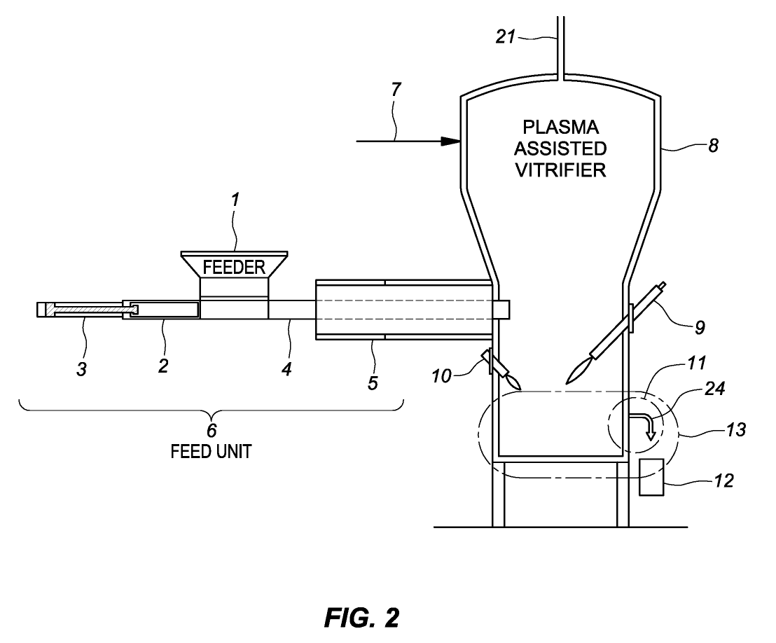

FIG. 1 depicts a process flow diagram that includes a plasma-assisted vitrifier (PAV) 8 and associated process equipment, in accordance with embodiments of the present disclosure. Embodiments of the present disclosure can include a plasma-based melter, such as PAV 8, for example. Referring first to FIG. 1, waste material can be fed into feed unit 6, which is connected to the PAV 8. FIG. 2 depicts a more detailed side view of the PAV 8 and feed unit 6 in FIG. 1, in accordance with embodiments of the present disclosure. The waste material can be drill cuttings, contaminated water, water treatment waste (e.g., water treatment waste such as MFT), CHOPS by-products and/or other artifacts of the oil and gas industry. In some embodiments, the contaminated water can include MFT or be comprised of primarily MFT. As depicted in FIG. 2, the feed unit 6 includes a hopper 1, a hydraulic ram 3, a receiver 2, a feed pipe 4, and a pre-heater 5. In some embodiments, the pre-heater 5 can heat the waste material to a particular temperature as it travels through the feed pipe 4, prior to the waste material being introduced into the PAV 8. In some embodiments, the feed pipe 4 can be fluidly connected to the PAV 8 and can be configured to deliver a feedstock into the PAV 8. The feed pipe 4 can enter the PAV 8 at a position that is located above one or more fossil fueled torches 10 and/or plasma torches 9. In some embodiments, the PAV 8 can be augmented by a fossil fueled torch 10 in addition to a plasma torch 9.

In an example, the hydraulic ram 3 can be connected to a piston, which is housed in the receiver 2. The receiver 2 can be connected to a base of the hopper 1. In some embodiments, waste material can be fed into the hopper 1. The hydraulic ram 3 can be actuated, causing the piston of the hydraulic ram 3 to extend from the receiver 2 and into a base of the hopper 1. The piston of the hydraulic ram 3 can be pushed across the base of the hopper 1 toward the feed pipe 4, thus pushing the waste material into the feed pipe 4. Upon pushing the waste material into the feed pipe 4, the hydraulic ram can be retracted, allowing waste material to flow back into the base of the hopper 1. In some embodiments, the hydraulic ram 3 can be cycled. For example, the piston of the hydraulic ram 3 can be extended and retracted to push waste material into the feed pipe 4 from the hopper 1.

In some embodiments, other feed units can be used, such as, but not limited to, augers or screw feed systems, macerating pumps, and/or injection systems as those known to ones skilled in the art. Other plasma melt systems, such as Alter NRG's coke-based plasma melter or Plasco's gas polishing and plasma vitrifying process, could potentially be substituted for the PAV 8 with varying degrees of success.

In the preferred embodiment, the waste material or feedstock enters the PAV 8, as shown in FIGS. 1 and 2. The PAV 8 details are described and taught in US publication no. 2014/0166934 titled, “Inductive Bath Plasma Cupola,” which is hereby incorporated by reference. In some embodiments, the PAV 8 can be a plasma-based melter. One or more fossil fueled torches 10, depicted in FIGS. 1 and 2 and/or one or more plasma torches 9, are again described in the above mentioned patent publication. One or more of each torch style can be utilized in embodiments of the present disclosure. The fossil fueled torch can be operated on well head gas, natural gas, propane, diesel, and/or bitumen. However, the fossil fueled torch can also be operated on other fuels.

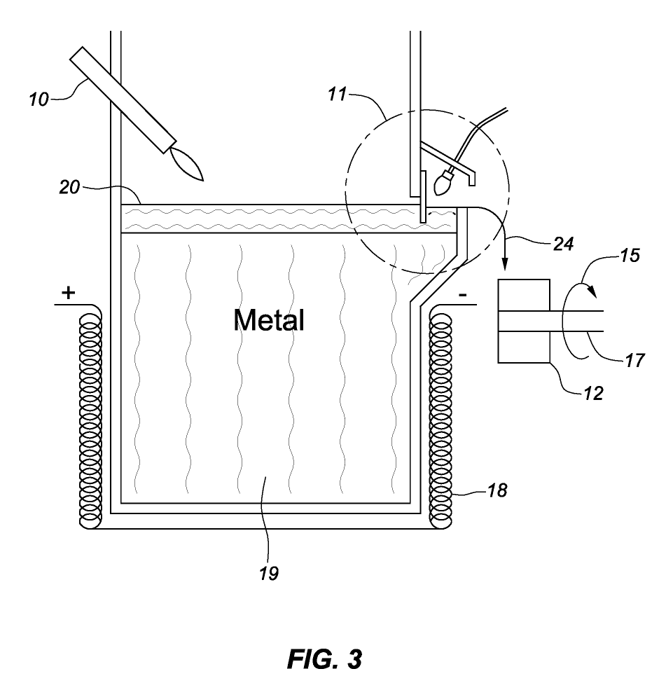

A more detailed view of the lower portion 13 of the PAV 8 in FIG. 1, as described in US publication no. 2014/0166934 and U.S. patent application Ser. No. 15/003,737 titled, “Vitrified Material Control System And Method,” is further depicted in FIGS. 2 and 3, which are both hereby incorporated by reference. The PAV 8 can be configured to produce vitrified product and can include a siphon valve 11, which is further described in U.S. patent application Ser. No. 15/003,737, which is hereby incorporated by reference. FIG. 3 depicts a more detailed side view of the lower portion 13 of the PAV 8 in FIGS. 1 and 2, in accordance with embodiments of the present disclosure. The lower portion 13 can include an inductive furnace 18, which can heat a metal thermal pool 19, and a feedstock working area 20, which can be heated by torch 10, as further described in U.S. patent application Ser. No. 15/003,737.

Some embodiments of the present disclosure can include a fiber production device configured to produce a fiber from a vitrified product 24 produced by the PAV 8. In some embodiments, vitrified product 24 can exit the lower portion 13 via siphon valve 11 and can be deposited onto spinner wheel 12 and/or multiple wheels to begin a fiberizing process. The spinner wheel 12 may be part of an internal fiberizing process or an external fiberizing process. As shown, the spinner wheel 12 can be disposed next to the PAV 8 and configured to receive the vitrified product, such that vitrified product produced by the plasma-based melter contacts the spinner wheel 12. In some embodiments, the spinner wheel 12 can be a spinning fiberizer. For example, the spinner wheel 12 can be an internal spinning fiberizer or an external spinning fiberizer. The spinner wheel 12 can rotate in a particular direction (e.g., arrow 15) on or about a longitudinal shaft 17, in some embodiments. The vitrified product 24 can contact the spinner wheel 12 as it is rotating, causing fibers to be formed as the vitrified product contacts the spinner wheel 12 and cools.

In some embodiments, one or more wheels of an external fiberizing process can also be used to manufacture a fracing sand product and other proppants known to those skilled in the art. As used herein, frac sand can be defined by, for example, standards ISO 13503-2 or API RP 56/58/60. Some embodiments of the present disclosure can include an aggregate production device configured to produce an aggregate from the vitrified product 24. In some embodiments, forced cooling systems using air or liquid (e.g., water) can be used to manufacture aggregate and facilitate the separation of reclaimed metals. As used herein, aggregate can be defined by, for example, standards ASTM D2940/D2940M-09. In some embodiments, the spinning fiberizer can be configured to produce a fiber.

Embodiments of the present disclosure described in relation to FIG. 1 can typically be operated in a slight pyrolysis mode. This is maintained by injecting a limited amount of oxygen and/or air and/or oxygen enriched air into the PAV 8, through combustion air inlet conduit 7. Efficiency can be gained by heating the combustion air using waste heat in heat exchangers 33 and 29. For example, exhaust produced by the process can be routed through the heat exchangers 33 and 29 to heat combustion air that is introduced into the PAV 8 and/or used for other purposes (e.g., drying). The system can also be operated in a stoichiometric condition, or a lean condition. However, if operated in a stoichiometric condition, or a lean condition, it can be more difficult to control NOx emissions in a cost-effective manner in a mass-production environment.

As shown in FIG. 1, syngas product can exit the PAV 8 from a top outlet assembly 21, which can include a conduit that is fluidly connected to a top of the PAV 8. The top outlet assembly 21 can be split and fluidly connected to a syngas product conduit 22 and an after burner feed conduit 38. Diluent and other high value products can be produced using Fisher Tropsch and other known chemical conversion systems or processes; or processes known to those skilled in the art in concert with a syngas supply provided by the syngas product conduit 22. The top outlet assembly 21 can be fluidly connected to an after burner feed conduit 38, which can be configured to provide an after burner 23 with syngas. The after burner 23 can be an emissions control device that is part of an emissions attenuation and/or control process; and can be configured to process a syngas product produced by the PAV 8 (e.g., oxidize the syngas product 38), which can flow through after burner feed conduit 38 and into after burner 23. The emissions attenuation and/or control process can also include various other devices to treat gaseous emissions generated by the plasma-based melter. For example, the emissions attenuation (e.g., emissions attenuator) and/or control process can include devices, such as, a cyclone 25, a selective non-catalytic reduction (SNCR) unit 28, a scrubber 30, a bag house 31, quench 32, and/or an exhaust stack 35 and can be configured to treat gaseous emissions generated by the plasma-assisted vitrifier. The after burner 23, cyclone 25, SNCR unit 28, scrubber 30, bag house 31, quench 32, and/or exhaust stack 35 can be fluidly connected with the PAV 8; and can be operated in series to control emissions and convert all available organic fuel into heat.

Cyclone 25 can be fluidly connected to the after burner 23 via a cyclone feed conduit 39, which can provide syngas that has been oxidized by the afterburner to the cyclone 25. The cyclone 25 can remove particulate matter from the processed syngas. A boiler 26 can be fluidly connected to the cyclone 25 via a boiler feed conduit 40. The boiler feed conduit 40 can be fluidly connected to a top of the cyclone 25. Thus, syngas (e.g., from syngas product conduit 22) or process heat, from afterburner 23 passing into the cyclone 25, can rise to a top of the cyclone and into the boiler feed conduit 40, while particulate matter can fall to a bottom of the cyclone 25. Removal of the particular matter from the syngas or process heat can aid in a long term health and/or efficiency of boiler 26. Process heat can be used or syngas (e.g., from syngas product conduit 22) can be combusted in the boiler 26 and used to heat a liquid (e.g., water) to make steam, which can be fed to the high pressure turbine 27 via steam conduit 41 and used to drive the high pressure turbine 27, which in turn can drive the generator 49.

In some embodiments, syngas product 22 can be provided to one or more energy generating combustion systems, such as an internal combustion engine, gas turbine generator, and/or a combined cycle gas generator system. In some embodiments, the syngas can be combusted in at least one of a simple cycle and a combined cycle turbine generator. In some embodiments, the energy generated by the high pressure turbine 27 and generator 49 and/or other energy generating combustion system can be used to self-power the waste remediation process.

A boiler exhaust can exit the boiler 26, which can be fed to the SNCR unit 28 via an SNCR feed conduit 42. The SNCR unit 28 can be a typical selective non catalytic system and process known to those skilled in the art. The SNCR unit 28 can be used for NOx treatment during operations that generate unacceptable levels of NOx. For example, the SNCR unit 28 can reduce and/or remove concentrations of mono-nitrogen oxides, such as nitric oxide and/or nitrogen dioxide. In some embodiments, an outlet 43 from the SNCR reactor 28 can be fed into a heat exchanger 29, which can pre-heat combustion air traveling through combustion air inlet conduit 7 into the PAV 8. For example, heat can be transferred from the effluent exiting the SNCR 28 via the heat exchanger 29, which can be used to pre-heat the combustion air. In some embodiments, the effluent from the SCNR 28 can be cooled via the heat exchanger 29 and be fed into a scrubber 30 via a scrubber feed conduit 44. The scrubber 30 can use a liquid (e.g., water, additive chemicals) to remove aerosol and/or gaseous pollutants from the cooled effluent from the heat exchanger 29 via absorption or chemical reactions with the liquid, in an example.

The scrubber 30 can be used in concert with bag house 31 and/or a ceramic filter system to remove injected sorbent (not shown) or other undesirable particulate from the effluent from the SCNR 28. For example, a bag house feed conduit 45 can fluidly connect the scrubber 30 and the bag house 31 to provide a scrubbed effluent to the bag house 31 from the scrubber 30. The bag house 31 can filter particulate matter out of the scrubbed effluent, in some embodiments. Quench 32 can be used as a further emissions control device and an exhaust gas process control device. In an example, quench feed conduit 46 can fluidly connect the bag house 31 to quench 32 to provide a feed from the bag house 31 to quench 32 from the bag house 31. In some embodiments, the feed from the bag house 31 can be quenched via quench 32, by cooling the feed with water sprays, in an example. In some embodiments, quench 32 can include an air inlet. The air inlet to quench 32 can provide air to quench 32, which can assist in lowering a temperature of the process flow passing through the quench 32, while increasing a mass flow and reducing and/or not allowing for energy loss due to latent heat transfer. In an example, pure water quench systems can allow for energy loss due to latent heat transfer. Inclusion of the air inlet can be beneficial because in some embodiments, a next process step can be heat recovery via heat exchanger 33. In some embodiments, an outlet 47 from quench 32 can fluidly connect the quench 32 and the heat exchanger 33. An output from quench 32 can be fed to the heat exchanger 33, which can pre-heat combustion air from a main combustion air inlet conduit 34.

The main combustion air inlet conduit 34 can pass through the heat exchanger 33 and can be split into two conduits. For example, the main combustion air inlet conduit 34 can be split into a drier feed conduit 50 and air inlet conduit 7. The drier feed conduit 50 can be fluidly connected to an optional feed drier system 37, which can be operated on fossil fuel, energy generated by the waste remediation process (e.g., via combustion of the syngas to generate steam and/or electricity), and/or waste heat from air passing through drier conduit 50 from heat exchanger 33. The feed drier system 37 can dry a feedstock provided to the PAV 8, in some embodiments.

In some embodiments, an output from quench 32 can travel through quench outlet 47, through heat exchanger 33, and into exhaust stack feed conduit 48. The exhaust stack feed conduit 48 can provide the output from quench 32 to the exhaust stack 35, which can release spent and acceptably clean exhaust gasses 36.

In some embodiments, a feed dryer system 37 that is run on fossil fuel, electricity, and/or waste heat can be optionally used to increase an efficiency of embodiments of the present disclosure. For example, heated air can travel through drier conduit 50 into the feed dryer system 37 to help dry the waste material or feedstock before it enters the PAV 8. In some embodiments, heated air can travel into the feed dryer system 37 and can be circulated and/or passed through the waste material or feedstock. After the air has been circulated about and/or passed through the waste material or feedstock, the air can be expelled from the feed dryer system 37 as waste heat.

Embodiments are described herein of various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment”, or the like, means that a particular feature, structure, or characteristic described in connection with the embodiment(s) is included in at least one embodiment. Thus, appearances of the phrases “in various embodiments,” “in some embodiments,” “in one embodiment,” or“in an embodiment,” or the like, in places throughout the specification, are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

Although at least one embodiment for an oil and gas waste stream remediation system, method, and apparatus has been described above with a certain degree of particularity, those skilled in the art could make numerous alterations to the disclosed embodiments without departing from the spirit or scope of this disclosure. All directional references (e.g., upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the devices. It will be further appreciated that for conciseness and clarity, spatial terms such as “vertical,” “horizontal,” “up,” and “down” may be used herein with respect to the illustrated embodiments. Joinder references (e.g., affixed, attached, coupled, connected, and the like) are to be construed broadly and can include intermediate members between a connection of elements and relative movement between elements. As such, joinder references do not necessarily infer that two elements are directly connected and in fixed relationship to each other. It is intended that all matter contained in the above description or shown in the accompanying drawings shall be interpreted as illustrative only and not limiting. Changes in detail or structure can be made without departing from the spirit of the disclosure as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed:

1. A system, comprising:
a plasma-assisted vitrifier configured to produce vitrified product;
a feed pipe fluidly connected to the plasma-assisted vitrifier, the feed pipe configured to deliver a feedstock into the plasma-assisted vitrifier;
a heated combustion air conduit fluidly connected to the plasma-assisted vitrifier;
a spinning fiberizer disposed next to the plasma-assisted vitrifier and configured to receive the vitrified product; and
an emissions attenuation device fluidly connected to the plasma-assisted vitrifier and configured to treat gaseous emissions generated by the plasma-assisted vitrifier.

2. The system of claim 1, wherein the spinning fiberizer is selected from the group consisting of an internal spinning fiberizer and an external spinning fiberizer.

3. The system of claim 1, wherein the spinning fiberizer is configured to produce a fiber.

4. A system, comprising:
a plasma-assisted vitrifier configured to produce syngas, process heat, and vitrified product;
a feed pipe fluidly connected to the plasma-assisted vitrifier, the feed pipe configured to deliver a feedstock into the plasma-assisted vitrifier;
a heated combustion air conduit fluidly connected to the plasma-assisted vitrifier;
a generator selected from the group consisting of a steam generation system and an electrical generation system, wherein the generator is configured to operate with at least one of the syngas and the process heat;
a device selected from the group consisting of an aggregate production device configured to produce an aggregate from the vitrified product and a fiber production device configured to produce a fiber from the vitrified product, wherein the device is disposed next to the plasma-assisted vitrifier; and
an emissions attenuator fluidly connected to the plasma-assisted vitrifier and configured to treat gaseous emissions generated by the plasma-assisted vitrifier.

5. The system of claim 4, wherein the fiber production device includes a spinning fiberizer selected from the group consisting of an internal spinning fiberizer and an external spinning fiberizer.

6. A system, comprising:
a plasma-assisted vitrifier configured to produce syngas and process heat;
a feed pipe fluidly connected to the plasma-assisted vitrifier, the feed pipe configured to deliver a feedstock into the plasma-assisted vitrifier;
a heated combustion air conduit fluidly connected to the plasma-assisted vitrifier;
a generator selected from the group consisting of a steam generation system and an electrical generation system, wherein the generator is configured to operate with at least one of the syngas and the process heat;
a device selected from the group consisting of an aggregate production device configured to produce an aggregate from the vitrified product and a fiber production device configured to produce a fiber from the vitrified product; and
an emissions attenuator fluidly connected to the plasma-assisted vitrifier and configured to treat gaseous emissions generated by the plasma-assisted vitrifier.

7. The system of claim 6, wherein the fiber production device configured to produce the fiber includes a spinning fiberizer selected from the group consisting of an internal spinning fiberizer and an external spinning fiberizer.

8. The system of claim 7, wherein the spinning fiberizer produces a fiber.

9. A system, comprising:
a plasma-assisted vitrifier configured to produce syngas and process heat;
a feed pipe fluidly connected to the plasma-assisted vitrifier, the feed pipe configured to deliver a feedstock into the plasma-assisted vitrifier;
a heated combustion air conduit fluidly connected to the plasma-assisted vitrifier;
a generator selected from the group consisting of a steam generation system and an electrical generation system, wherein the generator is configured to operate with at least one of the syngas and the process heat;
a device selected from the group consisting of an aggregate production device configured to produce an aggregate from the vitrified product and a fiber production device configured to produce a fiber from the vitrified product;
a siphon valve configured to control a flow of vitrified product from the plasma-assisted vitrifier to the device selected from the group consisting of the aggregate production device and the fiber production device; and
an emissions attenuator fluidly connected to the plasma-assisted vitrifier and configured to treat gaseous emissions generated by the plasma-assisted vitrifier.

10. The system of claim 9, wherein the fiber production device includes a spinning fiberizer selected from the group consisting of an internal spinning fiberizer and an external spinning fiberizer.

11. The system of claim 10, wherein the spinning fiberizer produces a fiber.

12. The system as in any one of claims 1, 4, 6, and 9, in which the feedstock is selected from the group consisting of drill cuttings and oil field waste.

13. The system of claim 12, wherein the oil field waste is contaminated water.

14. The system of claim 12, wherein the oil field waste is water treatment waste that includes Mature Fine Tailings (MFT).

15. The system of claim 12, wherein the oil field waste is cold heavy oil production with sand waste.

16. The system as in any one of claims 1, 4, 6, and 9, in which the plasma-assisted vitrifier is augmented by a fossil fuel torch.

17. The system as in any one of claims 1, 4, 6, and 9, further comprising a feed pipe drier that operates on at least one of waste heat and fossil fuel.

18. The system as in any one of claims 1, 4, 6, and 9, wherein syngas is produced by the plasma-assisted vitrifier and is used to produce a diluent through a Fisher Tropsch conversion.

19. The system as in any one of claims 4, 6, and 9, wherein the syngas is combusted in an internal combustion generator set to produce energy.

20. The system as in any one of claims 4, 6, and 9, wherein the syngas is combusted in a generator selected from the group consisting of a simple cycle generator and a combined cycle turbine generator.
